(19) United States
(12) Patent Application Publication
(10) Pub. No.: US 2024/0370010 A1
(43) Pub. Date: Nov. 7, 2024

(54) METHODS AND INTERNET OF THINGS (IOT) SYSTEMS FOR MONITORING SAFETY OF PIPELINE NETWORK VALVE WELLS BASED ON SMART GAS

(71) Applicant: CHENGDU QINCHUAN IOT TECHNOLOGY CO., LTD., Chengdu (CN)

(72) Inventors: Zehua SHAO, Chengdu (CN); Yong LI, Chengdu (CN); Lei ZHANG, Chengdu (CN); Zhubin CHENG, Chengdu (CN)

(73) Assignee: CHENGDU QINCHUAN IOT TECHNOLOGY CO., LTD., Chengdu (CN)

(21) Appl. No.: 18/774,902

(22) Filed: Jul. 16, 2024

(30) Foreign Application Priority Data
Apr. 10, 2024 (CN) 202410426070.7

(51) Int. Cl. G05B 23/02

(52) U.S. Cl. CPC G05B 23/0283

(57) ABSTRACT

The present disclosure provides a method and Internet of Things (IoT) system for monitoring safety of a pipeline network valve well based on smart gas, implemented by a smart gas pipeline network safety management platform of an IoT system for monitoring safety of a pipeline network valve well based on smart gas, comprising: obtaining gas monitoring data of a valve well; obtaining external environmental data of the valve well; determining anomaly assessment data of the valve well based on the gas monitoring data; determining risk assessment data of the valve well based on the external environmental data; determining a target maintenance valve well and a target scheduling strategy based on the anomaly assessment data and the risk assessment data, the target scheduling strategy including a count of scheduling personnel and a volume of scheduling bandwidth; and sending the target scheduling strategy to a smart gas pipeline network maintenance engineering object sub-platform.

### CROSS-REFERENCE TO RELATED APPLICATION

This application claims priority to Chinese Patent Application No. 202410426070.7, filed on Apr. 10, 2024, the entire contents of which are hereby incorporated by reference.

### TECHNICAL FIELD

The present disclosure relates to the field of smart gas technology, and in particular to a method and Internet of Things (IoT) system for monitoring safety of a pipeline network valve well based on smart gas.

### BACKGROUND

The valve well, as an important part of the gas pipeline, may become faulty or improperly used, leading to gas leakage or other dangerous situations. Therefore, the monitoring of the valve well is a necessary measure to ensure the safe and stable use of the gas pipeline.

CN108847002B provides a system for monitoring valve well fire and gas with an enhanced wireless communication signal, to understand and grasp the leakage situation of the valve well in time. However, the solution is merely for the field detection of an individual valve well, and lacks systematic measures for monitoring, maintenance, and scheduling of the valve well pipeline network.

Therefore, it is desirable to a method and Internet of Things (IoT) system for monitoring safety of a pipeline network valve well based on smart gas, to provide systematic monitoring and maintenance for the valve well.

### SUMMARY

One or more embodiments of the present disclosure provide a method for monitoring safety of a pipeline network valve well based on smart gas. The method may be implemented by a smart gas pipeline network safety management platform of an Internet of Things (IoT) system for monitoring safety of a pipeline network valve well based on smart gas, comprising: obtaining gas monitoring data of a valve well, the gas monitoring data including at least one of gas pressure data, gas flow data, gas temperature data, and gas humidity data; obtaining external environmental data of the valve well, the external environmental data including environmental water storage data; determining anomaly assessment data of the valve well based on the gas monitoring data; determining risk assessment data of the valve well based on the external environmental data; determining a target maintenance valve well and a target scheduling strategy based on the anomaly assessment data and the risk assessment data, the target scheduling strategy including a count of scheduling personnel and a volume of scheduling bandwidth; and sending the target scheduling strategy to a smart gas pipeline network maintenance engineering object sub-platform of the IoT system for monitoring safety of the pipeline network valve well based on smart gas.

One of the embodiments of the present disclosure provides an Internet of Things (IoT) system for monitoring safety of a pipeline network valve well based on smart gas, comprising a smart gas user platform, a smart gas service platform, a smart gas pipeline network safety management platform, a smart gas pipeline network sensor network platform, and a smart gas pipeline network object platform. The smart gas user platform may include a gas user sub-platform and a supervision user sub-platform. The smart gas service platform may include a smart gas usage service sub-platform and a smart supervision service sub-platform. The smart gas pipeline network safety management platform may include a smart gas pipeline network risk assessment management sub-platform and a smart gas data center. The smart gas sensor network platform may be configured to interact with the smart gas data center and the smart gas pipeline network object platform. The smart gas pipeline network object platform may include a smart gas pipeline network equipment object sub-platform and a smart gas pipeline network maintenance engineering object sub-platform. The smart gas pipeline network equipment object sub-platform may be configured to collect gas monitoring data of a valve well and external environmental data of the valve well. The smart gas pipeline network maintenance engineering object sub-platform may be configured to implement a target scheduling strategy for a target maintenance valve well. The smart gas pipeline network safety management platform may be configured to obtain the gas monitoring data of the valve well, the gas monitoring data including at least one of gas pressure data, gas flow data, gas temperature data, and gas humidity data; obtain the external environmental data of the valve well, the external environmental data including environmental water storage data; determine anomaly assessment data of the valve well based on the gas monitoring data; determine risk assessment data of the valve well based on the external environmental data; determine the target maintenance valve well and the target scheduling strategy based on the anomaly assessment data and the risk assessment data, the target scheduling strategy including a count of scheduling personnel and a volume of scheduling bandwidth; and send the target scheduling strategy to the smart gas pipeline network maintenance engineering object sub-platform.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic structural diagram illustrating platforms of an Internet of Things (IoT) system for monitoring safety of a pipeline network valve well based on smart gas according to some embodiments of the present disclosure;

FIG. 2 is a flowchart illustrating an exemplary method for monitoring safety of a pipeline network valve well based on smart gas according to some embodiments of the present disclosure;

FIG. 3 is a schematic diagram illustrating an exemplary process of determining anomaly assessment data according to some embodiments of the present disclosure;

FIG. 4 is a schematic diagram illustrating an exemplary process of determining anomaly assessment data according to some embodiments of the present disclosure; and

FIG. 5 is a flowchart illustrating an exemplary process of determining a target scheduling strategy according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person having ordinary skills in the art to apply the present disclosure to other similar scenarios in accordance with these drawings without creative labor. Unless obviously obtained from the context or the context illustrates otherwise, the same numeral in the drawings refers to the same structure or operation.

It should be understood that “system”, “device”, “unit” and/or “module” as used herein is a method for distinguishing different components, elements, portions, portions or assemblies of different levels. However, the words may be replaced by other expressions if other words can achieve the same purpose.

As indicated in the disclosure and claims, the terms “a”, “an”, and/or “the” are not specific to the singular form and may include the plural form unless the context clearly indicates an exception. Generally speaking, the terms “comprising” and “including” only suggest the inclusion of clearly identified steps and elements, and these steps and elements do not constitute an exclusive list, and the method or device may also contain other steps or elements.

The flowchart is used in the present disclosure to illustrate the operations performed by the system according to the embodiments of the present disclosure. It should be understood that the preceding or following operations are not necessarily performed in the exact order. Instead, various steps may be processed in reverse order or simultaneously. Meanwhile, other operations may be added to these procedures, or a certain step or steps may be removed from these procedures.

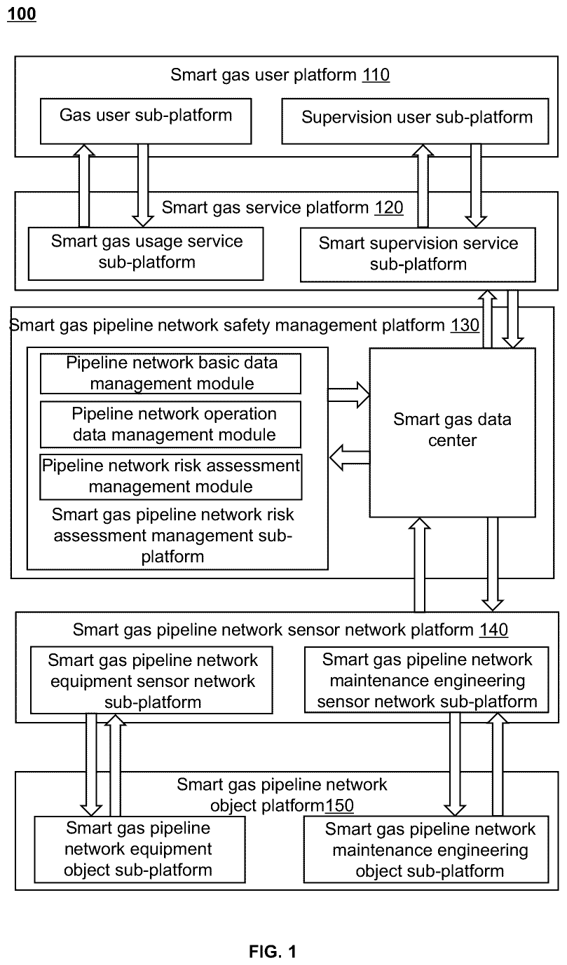

FIG. 1 is a schematic structural diagram illustrating platforms of an Internet of Things (IoT) system for monitoring safety of a pipeline network valve well based on smart gas according to some embodiments shown in the present disclosure. The IoT system for monitoring safety of the pipeline network valve well based on smart gas in the embodiments of the present disclosure will be described in detail below. It should be noted that the following embodiments are used only for explaining the present disclosure and do not constitute a limitation of the present disclosure.

As shown in FIG. 1, an IoT system 101 for monitoring safety of a pipeline network valve well based on smart gas may include a smart gas user platform 110, a smart gas service platform 120, a smart gas pipeline network safety management platform 130, a smart gas pipeline network sensor network platform 140, and a smart gas pipeline network object platform 150.

The smart gas user platform 110 refers to a platform for interacting with a user. For example, the smart gas user platform 110 may be configured as a terminal device.

In some embodiments, the smart gas user platform may include a gas user sub-platform and a supervision user sub-platform.

The gas user sub-platform refers to a platform that provides gas users with data related to gas usage and solutions to gas issues. The gas users may include an industrial gas user, a commercial gas user, an ordinary gas user, etc.

The supervision user sub-platform refers to a platform for a supervision user to supervise the operation of the entire IoT system. The supervision user may be a person in a safety management department.

The smart gas service platform 120 refers to a platform used to communicate user demand and/or control information.

In some embodiments, the smart gas service platform 120 may include a smart gas usage service sub-platform and a smart supervision service sub-platform.

The smart gas usage service sub-platform refers to a platform that provides gas services for the gas users.

The smart supervision service sub-platform refers to a platform that provides a supervision demand for the supervision user.

In some implementations, the smart gas usage service sub-platform and the smart supervision service sub-platform of the smart gas service platform 120 may interact with the gas user sub-platform and the supervision user sub-platform of the smart gas user platform 110, respectively.

The smart gas pipeline network safety management platform 130 refers to a platform that coordinates and collaborates the connection and cooperation between various functional platforms and aggregates all the information of the IoT to provide the functions of perception management and control management for an IoT operation system.

In some embodiments, the smart gas pipeline network safety management platform 130 may include a smart gas data center and a smart gas pipeline network risk assessment management sub-platform. In some embodiments, the smart gas pipeline network safety management platform 130 may be configured to obtain the gas monitoring data of a valve well and external environmental data of the valve well; determine anomaly assessment data of the valve well based on the gas monitoring data; determine risk assessment data of the valve well based on the external environmental data; determine a target maintenance valve well and a target scheduling strategy based on the anomaly assessment data and the risk assessment data, the target scheduling strategy including a count of personnel scheduling and a volume of scheduling bandwidth; and send the target scheduling strategy to the smart gas pipeline network maintenance engineering object sub-platform.

The smart gas data center may be configured to store and manage all operation information of the IoT system 100 for monitoring safety of the pipeline network valve well based on smart gas. In some embodiments, the smart gas data center may be configured as an acquisition and/or storage device for obtaining and/or storing data related to the valve well, pipelines, the users, etc. For example, the data may include the gas monitoring data of the valve well, the external environmental data of the valve well, gas usage of the users, a gas supply duration, and a probability of paying on time.

The smart gas pipeline network risk assessment management sub-platform refers to a platform for assessing and predicting a risk of gas pipeline network.

In some embodiments, the smart gas pipeline network risk assessment management sub-platform may include, but is not limited to, a pipeline network basic data management module, a pipeline network operation data management module, and a pipeline network risk assessment management module. The smart gas pipeline network risk assessment management sub-platform may be configured to analyze and process information related to the valve well through the management modules. For example, the smart gas pipeline network risk assessment management sub-platform may determine a risk assessment value of the valve well based on relevant data from the smart gas data center.

The smart gas pipeline network sensor network platform 140 refers to a functional platform that manages sensor communication of gas pipeline network equipment. For example, the smart gas pipeline network sensor network platform 140 may be configured as a communication network and gateway.

In some embodiments, the smart gas pipeline network sensor network platform 140 may include a smart gas pipeline network equipment sensor network sub-platform and a smart gas pipeline network maintenance engineering sensor network sub-platform.

The smart gas pipeline network equipment sensor network sub-platform refers to a platform for obtaining and transmitting operation information of the gas pipeline network equipment. For example, the smart gas pipeline network equipment sensor network sub-platform may obtain the gas monitoring data and the external environmental data of the valve well from the smart gas pipeline network equipment object sub-platform and upload the gas monitoring data and the external environmental data of the valve well to the smart gas data center.

The smart gas pipeline network maintenance engineering sensor network sub-platform refers to a platform for obtaining and transmitting operation information of gas pipeline network maintenance engineering. For example, the smart gas pipeline network maintenance engineering sensor network sub-platform may obtain the target maintenance valve well and the target scheduling strategy from the smart gas data center and send the target maintenance valve well and the target scheduling strategy to the smart gas pipeline network maintenance engineering object sub-platform.

The smart gas pipeline network object platform 150 refers to a functional platform for perception information generation and control information execution. For example, the smart gas pipeline network object platform 150 may be configured as various types of pipeline network equipment.

In some embodiments, the smart gas pipeline network object platform may include, but is not limited to, the smart gas pipeline network equipment object sub-platform and the smart gas pipeline network maintenance engineering object sub-platform.

In some embodiments, the smart gas pipeline network equipment object sub-platform may be configured as various types of pipeline network equipment. For example, the smart gas pipeline network equipment object sub-platform may be the valve well, the gas pipeline, and a corresponding sensor (e.g., a pressure sensor, a flow sensor, a temperature sensor, a humidity sensor, a water level sensor, a water turbidity sensor, and vibration measurement equipment) configured for the valve well and/or the pipeline.

The smart gas pipeline network maintenance engineering object sub-platform refers to a platform for maintaining the gas pipeline network equipment. The smart gas pipeline network maintenance engineering object sub-platform may include an intelligent terminal used by maintenance personnel and network equipment that manages a data upload bandwidth for the valve well or the pipeline network. In some embodiments, the smart gas pipeline network maintenance engineering object sub-platform may be configured to obtain the target maintenance valve well and the target scheduling strategy, and control the intelligent terminals corresponding to the maintenance personnel within the count of scheduling personnel to direct the target maintenance valve well according to the count of scheduling personnel in the target scheduling strategy; and control the corresponding network equipment to adjust the data upload bandwidth according to the volume of scheduling bandwidth in the target scheduling strategy.

By means of the IoT system 100 for monitoring safety of the pipeline network valve well based on smart gas, a closed loop of information operation may be formed between the functional platforms, and coordinated and regular operation may be achieved under the unified management of the smart gas pipeline network safety management platform 130, to realize the informationization and intelligentization of the safety monitoring of the pipeline network valve well based on smart gas.

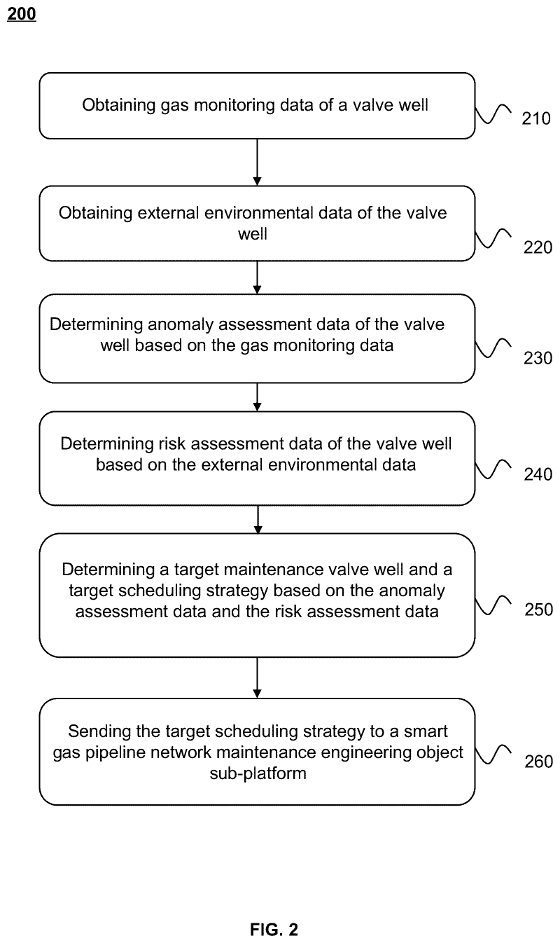

FIG. 2 is a flowchart illustrating an exemplary method for monitoring safety of a pipeline network valve well based on smart gas according to some embodiments of the present disclosure. As shown in FIG. 2, a process 200 may include the following operations. In some embodiments, the process 200 may be performed by the smart gas pipeline network safety management platform 130.

In 210, gas monitoring data of a valve well may be obtained.

The valve well, also referred to as a gas meter well, is internally provided with a control valve for controlling a gas pipeline network. The valve well may make it easy to open and close a portion of the network for operation or maintenance.

The gas monitoring data refers to data generated by monitoring a gas status.

In some embodiments, the gas monitoring data may include at least one of gas pressure data, gas flow data, gas temperature data, and gas humidity data.

The smart gas pipeline network safety management platform 130 may obtain the gas monitoring data from a smart gas pipeline network equipment object sub-platform through a smart gas pipeline network sensor network platform.

In some embodiments, the gas monitoring data may also include valve well monitoring data and pipeline monitoring data.

The valve well monitoring data refers to monitoring data related to the valve wells, such as a gas pressure and a flow rate at a valve of the valve well.

The pipeline monitoring data refers to monitoring data related to a gas pipeline connected to the valve well, such as a pressure or a flow rate of the gas pipeline connected to a certain valve well.

An acquisition frequency refers to a frequency of obtaining the gas monitoring data. The acquisition frequency of the valve well monitoring data may be a first acquisition frequency, and the acquisition frequency of the pipeline monitoring data may be a second acquisition frequency. The first acquisition frequency and the second acquisition frequency may be set in advance.

In some embodiments, the first acquisition frequency may be greater than the second acquisition frequency. It is understood that a position of the valve well may be a position of the valve. The position of the valve may be more likely to be anomalous, and thus may need to be monitored more closely. The pipeline connected to the valve well may be affected by the valve well, and may also be more likely to be anomalous, and the closer to the valve well, the greater the impact.

In some embodiments, the second acquisition frequency may be negatively correlated with a distance between the gas pipeline and a valve well closest to the gas pipeline.

For example, the smaller the distance between the gas pipeline and the valve well closest to the gas pipeline, the second acquisition frequency may be appropriately increased.

Since the position of the valve is more susceptible to anomalies such as leakage and rainwater corrosion, higher frequency monitoring of the valve well and the pipeline close to the valve well may effectively detect the anomalies.

In 220, external environmental data of the valve well may be obtained.

The external environmental data refers to data related to an external environment in which the valve well is located. In some embodiments, the external environmental data may include environmental water storage data.

The environmental water storage data refers to data reflecting a water storage situation of the external environment in which the valve is located, e.g., an amount of water storage, an area of water storage, or the like.

The smart gas pipeline network safety management platform 130 may obtain the external environmental data from the smart gas pipeline network equipment object sub-platform through the smart gas pipeline network sensor network platform.

In 230, anomaly assessment data of the valve well may be determined based on the gas monitoring data.

The anomaly assessment data refers to assessment data reflecting an inherent anomaly of the valve well. The anomaly assessment data may be expressed in terms of an assessment score or grade, etc. The inherent anomaly may include an anomaly occurring in the valve well (e.g., the valve or the pipeline).

In some embodiments, the anomaly assessment may include an anomaly type and/or an anomaly degree of the inherent anomaly occurring in the valve well at a current and/or future time point.

The inherent anomaly refers to an anomaly occurring in the valve well due to the effect of an inherent factor. For example, the inherent anomaly may include gas leakage, water leakage, and a gas flow data anomaly due to aging of the valve, a design defect in a connection between the valve well and the pipeline, or power depletion of a gas flow meter.

The anomaly type refers to a type of the inherent anomaly, such as gas leakage, an equipment failure, etc.

The anomaly degree refers to data that characterizes a severity of the inherent anomaly. For example, the anomaly degree may be slight, severe, etc. The anomaly degree may be determined based on data associated with the inherent anomaly. For example, the anomaly degree of the gas leakage may be determined based on a loss of flow caused by the gas leakages. For example, the greater the loss of flow, the higher the anomaly degree. The loss of flow may be determined based on flow data from valve well inspection data or flow data from the pipeline monitoring data.

In some embodiments, if the anomaly degree of the inherent anomaly at a current time point is relatively high, the anomaly degree of the inherent anomaly at a current time point may gradually increase.

In some embodiments, the smart gas pipeline network safety management platform 130 may use a difference between the gas monitoring data and a monitoring data threshold as the anomaly assessment data. The monitoring data threshold may be set based on experience.

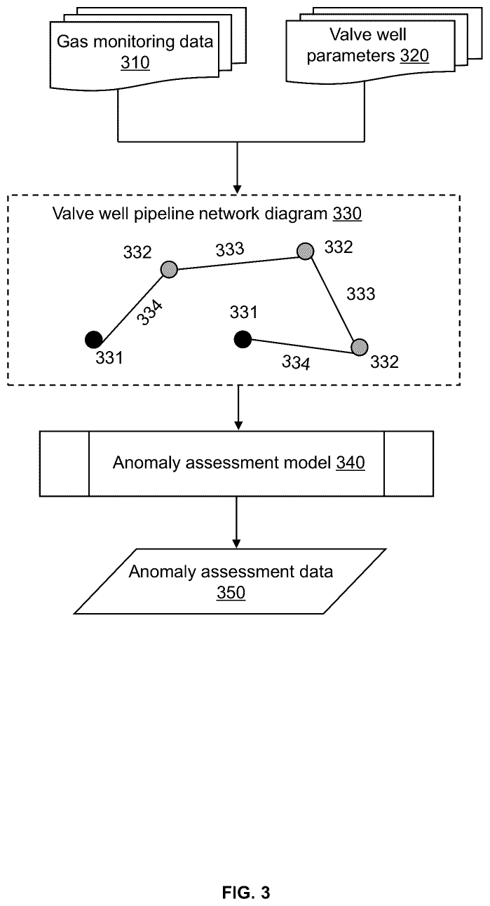

The smart gas pipeline network safety management platform 130 may also determine the anomaly assessment data in other ways. For example, the smart gas pipeline network safety management platform 130 may construct a valve well pipeline network diagram based on the gas monitoring data and valve well parameters; and determine the anomaly assessment data through an anomaly assessment model based on the valve well pipeline network diagram. More descriptions may be found in FIG. 3 and related descriptions thereof.

In 240, risk assessment data of the valve well may be determined based on the external environmental data.

The risk assessment data refers to assessment data that reflects an extrinsic risk occurring the valve well. The risk assessment data may be expressed in terms of an assessment score or grade, etc.

In some embodiments, the risk assessment data may include a risk value of the extrinsic risk occurring in the valve well.

The extrinsic risk refers to a risk of the valve well caused by the of an external factor, such as the external environment. For example, the extrinsic risk may include water leakage, corrosion, deformation, damage, collapse, or the like, due to water storage, soil quality, heavy pressure, or the like.

The risk value refers to a numerical value reflecting the degree of risk, and a range of the numerical value may be set in advance.

In some embodiments, the smart gas pipeline network safety management platform 130 may use a difference between the external environmental data and a environmental data threshold as the risk assessment data. The environmental data threshold may be set in advance based on experience.

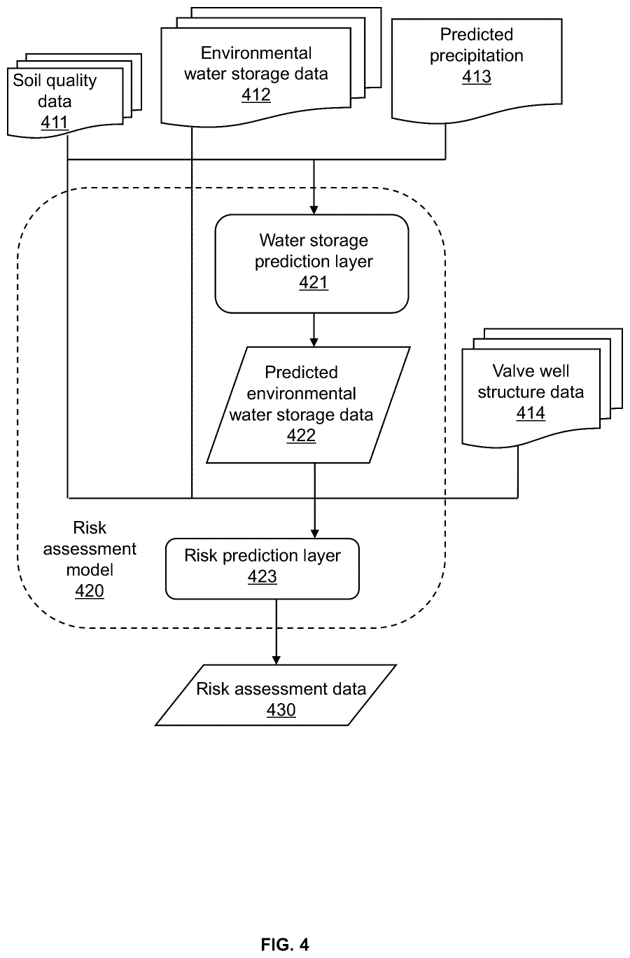

The smart gas pipeline network safety management platform 130 may also determine the risk assessment data of the valve well in other ways. For example, the smart gas pipeline network safety management platform 130 may determine the risk assessment data through a risk assessment model based on at least one of the environmental water storage data, soil quality data, and valve well structure data. More descriptions may be found in FIG. 4 and related descriptions thereof.

In 250, a target maintenance valve well and a target scheduling strategy may be determined based on the anomaly assessment data and the risk assessment data, the target scheduling strategy including a count of scheduling personnel and a volume of scheduling bandwidth.

The target maintenance valve well refers to a valve well that needs maintenance.

In some embodiments, for each valve well, the smart gas pipeline network safety management platform 130 may determine a first emergency degree of the valve well by performing weighted summation based on the anomaly degree in the anomaly assessment data, the risk value in the risk assessment data, and an importance degree of the valve well, a first weighting coefficient of the weighted summation being preset based on experience; and determine a valve well of which the first emergency degree satisfies a first emergency condition as the target maintenance valve well based on the first emergency degree of each valve well.

If a certain valve well has a plurality of anomalies corresponding to a plurality of anomaly degrees, the smart gas pipeline network safety management platform 130 may calculate the first emergency degree based on a maximum value of the plurality of anomaly degrees.

In some embodiments, the smart gas pipeline network safety management platform 130 may determine the importance degree of the valve well by performing weighted summation on a mean value of importance degrees of associated pipelines and a count of the associated pipelines. A second weighting coefficient of the weighted summation may be preset based on experience.

The associated pipelines refer to pipelines connected to the same valve well. The count of the associated pipelines may be positively correlated with the importance degree of the valve well. For example, the more the count of the associated pipelines, the higher the importance degree of the valve well. The smart gas pipeline network safety management platform 130 may construct a pipeline diagram, and determine the associated pipelines based on the pipeline diagram. In the pipeline diagram, nodes may include valve well nodes, pipeline nodes, and user nodes, and edges may include a connection relationship between the valve well and the pipeline, and a connection relationship between the pipelines, and a connection relationship between the pipeline and the user. More descriptions regarding the method of constructing the pipeline diagram may be found in a method of constructing a valve well pipeline network diagram in FIG. 3.

The mean value of the importance degrees of the associated pipelines refers to an average value of the importance degrees of all the associated pipelines of a certain valve well, which may be determined based on the importance degree of each of the associated pipelines. The importance degree of one of the associated pipelines may be calculated by Equation 1:

I=r₁*I₁+r₂*I₂+ . . . +rₙ*Iₙ (1)

wherein I denotes the importance degrees of the associated pipelines, rₙ denotes a coefficient of a path n, and Iₙ denotes an importance degree of an end node n. An end node 1, . . . , and the end node n respectively denote a user node 1, . . . , and a user node n that can be reached with the associated pipeline as a starting point. A path 1, a path 2, . . . , and a path n denote n paths for the associated pipeline to reach the user node 1, . . . , and the user node n, respectively. The path coefficient r₁ . . . rₙ may be preset based on experience. “Reach” refers to be reachable in a direction of gas flow. An out degree of the end point may be 0.

The path coefficient may be positively correlated with a path length of the path. The path length refers to how many nodes are passed in total to a corresponding end node with the associated pipeline as the starting point, i.e., a node proximity. The more upstream the pipeline node corresponding to the associated pipeline, the higher the importance degree of the associated pipeline.

In some embodiments, the importance degree of the end node may be used to characterize the importance degree of the user. The smart gas pipeline network safety management platform 130 may determine the importance degree of the end node by performing weighted summation on the gas usage of the user, the gas supply duration, and the probability of paying on time. A third weighting factor of the weighted summation may be preset based on experience. The gas usage of the user, the gas supply duration, and the probability of paying on time may be obtained based on the smart gas data center.

In some embodiments, when the smart gas pipeline network safety management platform 130 determines whether the first emergency degree satisfies the first emergency condition, the first emergency condition may include that the first emergency degree is greater than a first emergency threshold. The first emergency threshold may be preset based on experience.

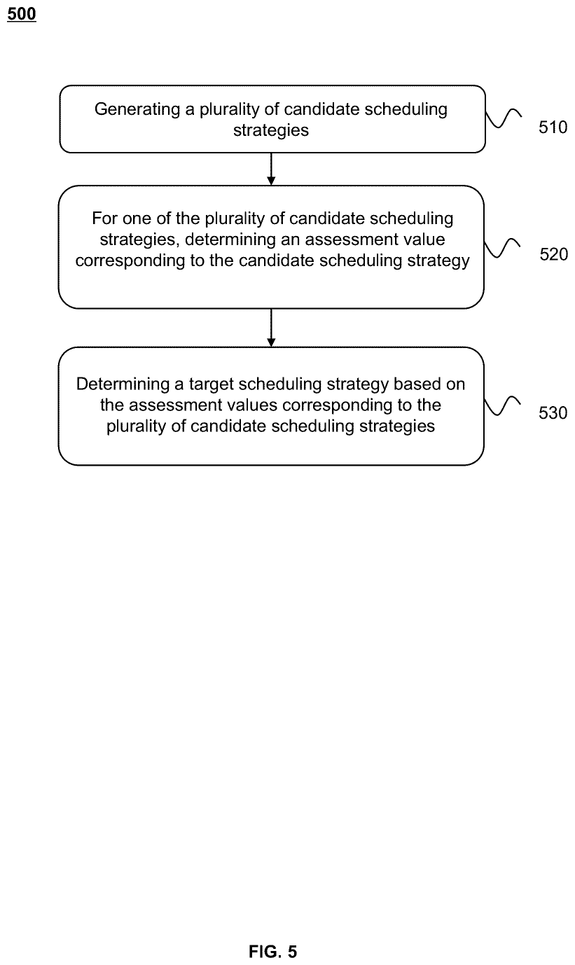

The smart gas pipeline network safety management platform 130 may also determine the target maintenance valve well in other ways. For example, the smart gas pipeline network safety management platform 130 may determine the target maintenance valve well based on the anomaly type and/or the anomaly degree in the anomaly assessment data at the future time point and the risk value in the risk assessment data at the future time point. More descriptions may be found in FIG. 5 and related descriptions thereof.

The target scheduling strategy refers to a scheduling strategy for maintenance of the target maintenance valve well. The target scheduling strategy may include maintenance resources allocated to the target maintenance valve well. In some embodiments, the target scheduling strategy may include the count of scheduling personnel and the volume of scheduling bandwidth.

The count of scheduling personnel refers to a count of maintenance personnel dispatched to the target maintenance valve well for maintenance. The volume of scheduling bandwidth refers to a volume of bandwidth scheduled to the target maintenance valve well for data upload. The larger the volume of scheduling bandwidth, the more data that may be uploaded by the target maintenance valve well, and the higher the frequency at which the target maintenance valve well is allowed to upload the data.

In some embodiments, the smart gas pipeline network safety management platform 130 may determine the target scheduling strategy by querying a scheduling strategy table based on the anomaly assessment data and the risk assessment data. The scheduling strategy table may include a plurality of anomaly assessment data and weights thereof, a plurality of risk assessment data and weights thereof, and a correspondence of a plurality of scheduling strategies, and may be determined by preset.

The smart gas pipeline network safety management platform 130 may also determine the target scheduling strategy in other ways. For example, the smart gas pipeline network safety management platform 130 may generate a plurality of candidate scheduling strategies; for one of the plurality of candidate scheduling strategies, determine an assessment result corresponding to the candidate scheduling strategy; and determine the target scheduling strategy based on the assessment results corresponding to the plurality of candidate scheduling strategies. More descriptions may be found in FIG. 5 and related descriptions thereof.

In 260, the target scheduling strategy may be sent to the smart gas pipeline network maintenance engineering object sub-platform.

In some embodiments, the smart gas pipeline network safety management platform 130 may send the target scheduling strategy to the smart gas pipeline network maintenance engineering object sub-platform through the smart gas pipeline network maintenance engineering sensor network sub-platform.

According to some embodiments of the present disclosure, the anomaly assessment data and the risk assessment data may be determined based on monitoring data and the external environmental data of the valve well, and then the target maintenance valve well and the target scheduling strategy may be determined. The intrinsic and extrinsic anomalies occurring in the valve well may be determined, and a targeted scheduling strategy may be formulated, such that monitoring of the valve well is more comprehensive and accurate, and allocation of the personnel is more reasonable.

It should be noted that the foregoing description of the process 200 is intended to be exemplary and illustrative only, and does not limit the scope of application of the present disclosure. For a person skilled in the art, various corrections and changes to the process 200 may be made under the guidance of the present disclosure. However, these corrections and changes remain within the scope of the present disclosure.

FIG. 3 is a schematic diagram illustrating an exemplary process of determining anomaly assessment data according to some embodiments of the present disclosure.

In some embodiments, the smart gas pipeline network safety management platform 130 may construct a valve well pipeline network diagram based on gas monitoring data and valve well parameters; and determine anomaly assessment data through an anomaly assessment model based on the valve well pipeline network diagram.

The valve well parameters refer to parameters related to physical properties of a valve well, such as a size of a wellhead, a depth of the valve well, or the like.

The valve well pipeline network diagram refers to a graphical structure of a valve well pipeline network that characterizes a distribution of the valve well and a distribution of pipelines connected to the valve well.

The smart gas pipeline network safety management platform 130 may obtain a valve well pipeline network diagram 330 with a certain data structure (e.g., an adjacency matrix, an adjacency table, etc.) through data processing and modeling based on gas monitoring data 310 and valve well parameters 320.

In some embodiments, nodes in the valve well pipeline network diagram may include valve well nodes 331 and pipeline nodes 332; and edges in the valve well pipeline network diagram may include a connection relationship 333 between the pipelines and a connection relationship 334 between the valve well and the pipeline.

The pipeline nodes and the valve well nodes refer to nodes used to characterize the pipelines and the valve wells, respectively, in the valve well pipeline network diagram. The pipeline nodes and the valve well nodes correspond to corresponding pipeline node features and valve well node features, respectively.

The pipeline node features may include pipeline monitoring data and pipeline features.

The pipeline features refer to features related to physical properties of the pipelines, such as sizes of the pipelines. The gas pipeline features may be obtained through user preset, etc.

The valve well node features may include at least one of valve well monitoring data, valve well parameters, valve well usage time, an opening and closing status of a valve, or the like. In some embodiments, the valve well node features may include environmental water storage data corresponding to the valve well.

More descriptions regarding the pipeline monitoring data, the valve well monitoring data, and the environmental water storage data may be found in FIG. 2 and related descriptions thereof.

In some embodiments, the edges may include a first type of edges for connecting the valve well nodes and the pipeline nodes, or a second type of edges for connecting the pipeline nodes. Edge features may include a distance between two connected nodes and a flow rate of gas between the two connected nodes.

The connection between the pipelines and the valve wells may be reflected by the nodes, and the relationship between the nodes may be reflected by the edges. A distribution of the valve wells and the pipelines may be clearly reflected based on the constructed valve well pipeline network diagram, which is conducive to more accurately predicting the anomaly assessment data of the valve wells subsequently through the anomaly assessment model. The environmental water storage data may be included in the valve well node features, and an actual geography of a specific region may be considered when the anomaly assessment data of the valve wells is predicted, which is conducive to obtaining the more accurate anomaly assessment data based on the regional environment. For example, in some region of the southeast coast, the underground water level is relatively high, and the situation of water storage is more severe.

More descriptions regarding the extrinsic anomalies, the anomaly assessment data, the anomaly type, the anomaly degree, etc. may be found in FIG. 2 and related descriptions thereof.

In some embodiments, an anomaly assessment model 340 may be a machine learning model. For example, the anomaly assessment model 340 may include a graph neural network model (GNN). In some embodiments, an input of the anomaly assessment model 340 may include the valve well pipeline network diagram 330, and an output of the anomaly assessment model 340 may include anomaly assessment data 350 of the valve well nodes.

In some embodiments, the smart gas pipeline network safety management platform 130 may obtain the anomaly assessment model by train an initial anomaly assessment model based on a plurality of first training samples and first labels thereof through a gradient descent method, or the like.

In some embodiments, the plurality of first training samples may include a sample valve well pipeline network diagram, which may be obtained from historical data. The first labels corresponding to the plurality of first training samples may be historical anomaly assessment data of each valve well corresponding to the sample valve well pipeline network diagram, and may be determined by manual labeling or automatic labeling. An anomaly degree in the historical anomaly assessment data of each valve well corresponding to the sample valve well pipeline network diagram may be determined based on an anomaly severity of an intrinsic anomaly actually occurring in the valve well.

In some embodiments of the present disclosure, the valve well pipeline network diagram may be constructed based on the gas monitoring data and the valve well parameters; the anomaly assessment data may be determined through the anomaly assessment model based on the valve well pipeline network diagram, such that the internal relationship between the gas monitoring data, the valve well parameters, and the anomaly assessment data can be mined, and the determination accuracy of the anomaly assessment data can be improved; the anomaly assessment data may include the anomaly type and/or the anomaly degree of the inherent anomaly occurring in the valve well at the current time point and/or the future time point, which is conducive to providing a reference for the subsequent determination of the target maintenance valve wells and the target scheduling strategy, so as to take more reasonable maintenance measures.

FIG. 4 is a schematic diagram illustrating an exemplary process of determining anomaly assessment data according to some embodiments of the present disclosure.

In some embodiments, the smart gas pipeline network safety management platform 130 may determine risk assessment data 430 through a risk assessment model 420 based on at least one of environmental water storage data 412, soil quality data 411, and valve well structure data 414.

In some embodiments, the environmental water storage data may include a turbidity degree of water storage and/or a water level of water storage. More descriptions regarding the environmental water storage data may be found in FIG. 2 and related descriptions thereof.

The turbidity degree of water storage refers to a turbidity degree of water storage outside a valve well. For example, the turbidity degree of water storage may be expressed as a score or a grade.

The water level of water storage refers to a water level of water storage outside the valve well. For example, the water level of water storage may be expressed as a height value or a grade.

The smart gas pipeline network safety management platform 130 may obtain the environmental water storage data by obtaining the water level of water storage and the turbidity degree of water storage based on a smart gas pipeline network equipment object sub-platform, and store the environmental water storage data. The water level of water storage and the turbidity degree of water storage obtained at a current time point may be a current water level of water storage and a current turbidity degree of water storage. A water level of water storage and a turbidity degree of water storage at a historical time point may be a historical water level of water storage and a historical turbidity degree of water storage.

The soil quality data refers to data reflecting a soil condition around the valve well, such as soil composition, soil looseness, soil porosity, etc. It should be understood that soil with different soil quality data has different resistance to erosion. For example, the soil with higher soil looseness is more susceptible to water erosion and has a greater risk of collapse; and the soil with greater soil porosity is more easily permeable to water. The smart gas pipeline network safety management platform 130 may obtain the soil quality data near the valve well based on a third-party platform or based on user input through a communication interface or an interaction interface.

The valve well structure data refers to parameters related to structural features of the valve well. The valve well structure data may include valve well parameters, a valve well material, maximum load bearing of the valve well, maximum pressure bearing of the valve well, or the like. The maximum load bearing of the valve well may be obtained by pre-experiment. The v maximum pressure bearing of the valve well refers to a minimum pressure to make the valve well leak. The smart gas pipeline network safety management platform 130 may obtain the valve well structure data based on the user input through the communication interface or the interaction interface. More descriptions regarding the valve well parameters may be found in FIG. 2 and related descriptions thereof.

More descriptions regarding the extrinsic risks, the risk assessment data, and the risk value may be found in FIG. 2 and related descriptions thereof.

In some embodiments, an input of a risk assessment model may include at least one of the environmental water storage data, the soil quality data, and the valve well structure data; and an output of the risk assessment model may include the risk assessment data. The environmental water storage data may include the current water level of water storage, the historical water level of water storage, the current turbidity degree of water storage, and the historical turbidity degree of water storage.

In some embodiments, the input of the risk assessment model may also include environmental vibration data and/or the anomaly assessment data of the valve well.

The environmental vibration data refers to data that reflects environmental vibration around the valve well. The smart gas pipeline network safety management platform 130 may obtain the environmental vibration data from a vibration measurement device (e.g., a vibration sensor, an accelerometer, etc.) included in the smart gas pipeline network equipment object sub-platform through a smart gas pipeline network sensor network platform.

In some embodiments, when the water level of water storage is less than a water level threshold, the smart gas pipeline network safety management platform 130 may determine a risk assessment value directly based on the environmental vibration data. For example, the greater the environmental vibration data, the higher the risk assessment value.

The input of the risk assessment model may include an anomaly type and/or an anomaly degree in the anomaly assessment data. More descriptions regarding the anomaly type and the anomaly degree may be found in FIG. 2 and related descriptions thereof.

In some embodiments of the present disclosure, the environmental vibration data may be used as one of the input to the risk assessment model, such that the possible effects of the environmental vibration on the valve well can be considered, and the determination accuracy of the risk assessment data can be improved; and a reference can be provided for predicting the extrinsic risks occurring in the valve well through the environmental vibration data if there is no water storage or the water level water storage is very low. It should be understood that if the valve well has the intrinsic anomaly such as gas leakage and water leakage, in the presence of a certain extrinsic risks, the risk value of the extrinsic risk of the valve well may be increased, and the valve well may be more prone to problems. Therefore, using the anomaly assessment data as one of the input to the risk assessment model may discover the correlation between the intrinsic anomalies of the valve well and the extrinsic risks, thereby improving the determination accuracy of the risk assessment data.

In some embodiments, the risk assessment model may be a machine learning model. For example, the risk assessment model may include a Convolutional Neural Networks (CNN) model, Neural Networks (NN), or any combination thereof.

In some embodiments, the risk assessment model may be obtained by training based on second training samples and second labels. The second training samples may include sample environmental water storage data, sample soil quality data, sample valve well structure data, etc. The sample environmental water storage data may include a water level of water storage corresponding to a first historical time point, a water level of water storage corresponding to a second historical time point, a turbidity degree of water storage corresponding to the first historical time point, and a turbidity degree of water storage corresponding to the second historical time point. The first historical time point may precede the second historical time point.

In some embodiments, when the input of the risk assessment model includes the environmental vibration data and/or the anomaly assessment data of the valve well, the second training samples may also include sample environmental vibration data and/or sample anomaly assessment data. The second training sample may be obtained based on historical data. The second labels may include actual risk values of sample valve wells at the second historical time point, and may be determined by manual labeling or automatic labeling.

For example, the second labels may be labeled as actual risk values within a range of 1-100. In some embodiments, if the sample valve wells operate properly in an environment corresponding to a set of second training samples, the second labels corresponding to the set of second training samples may be labeled as the actual risk values within a first range. The risk values within the first range may be relatively small risk values, e.g., below 40. The actual risk values within the first range may be positively correlated with the environmental water storage data.

If the sample valve wells have an anomaly such as water leakage or structural deformation in the environment corresponding to the set of second training samples, the second labels corresponding to the set of second training samples may be labeled as risk assessment values within a second range. The risk values within the second range may be relatively large risk values, e.g., above 70. The risk values within the second range may be proportional to the severity of the anomaly.

In some embodiments, the risk assessment model may include a water storage prediction layer 421 and a risk prediction layer 423.

The water storage prediction layer 421 may be configured to determine predicted environmental water storage data 422 based on at least one of the environmental water storage data 412, predicted precipitation 413, and the soil quality data 411. The predicted environmental water storage data 422 output by the water storage prediction layer 421 may be used as an input to the risk prediction layer 423. More descriptions regarding the environmental water storage data may be found in FIG. 2 and related descriptions thereof.

The predicted precipitation refers to predicted precipitation at the position of the valve well and may include predicted precipitation at a current time point and at least one future time point. In some embodiments, the smart gas pipeline network safety management platform 130 may obtain the predicted precipitation through a third-party platform. For example, the third-party platform may include a weather forecast network, etc.

The predicted environmental water storage data refers to predicted environmental water storage data at the future time point. The predicted environmental water storage data may include the environmental water storage data of the valve well of at least one future time point. For example, the water storage prediction layer 421 may input the environmental water storage data 412 at a current time point 10:00, and the water storage prediction layer 421 may output the predicted environmental water storage data 422 at future time points of 10:30, 11:00, 11:30, etc.

The risk prediction layer 423 may be configured to input at least one of the environmental water storage data 412, the predicted environmental water storage data 422, the valve well structure data 414, and the soil quality data 411, and output the risk assessment data 430.

In some embodiments, the risk assessment data may include a risk value of the extrinsic risk occurring in the valve well at the future time point. One or more risk assessment data 430 may be provided, and the one or more risk assessment data 430 may correspond to a volume of the predicted environmental water storage data.

Merely by way of example, after the water storage prediction layer 421 outputs the predicted environmental water storage data at the future time points 10:30, 11:00, 11:30, etc., the risk prediction layer may input the predicted environmental water storage data at the future time points 10:30, 11:00, 11:30, etc., and output the risk values at the future time points 10:30, 11:00, 11:30, etc. The future time point may be determined as required, which is not limited here.

The water storage prediction layer and the risk prediction layer may be obtained by training separately.

In some embodiments, sample data for training the water storage prediction layer may include third training samples and third labels. Each set of third training samples may include sample environmental water storage data, sample predicted precipitation, and sample soil quality data. The sample environmental water storage data may include a water level of water storage corresponding to a third historical time point and a turbidity degree of water storage corresponding to the third historical time point. The third labels may include actual environmental water storage data of at least one fourth historical time point corresponding to the each set of third training samples. The third training samples may be obtained based on historical data, and the third labels may be determined by manual labeling or automatic labeling. The third historical time point may precede the fourth historical time point.

Sample data for training the risk prediction layer may include fourth training samples and fourth labels. Each set of the fourth training samples may include sample environmental water storage data, sample predicted environmental water storage data, sample soil quality data, and sample valve well structure data. The sample environmental water storage data may include a water level of water storage corresponding to a fifth historical time point and a turbidity degree of water storage corresponding to the fifth historical time point. The sample predicted environmental water storage data may include a water level of water storage corresponding to a sixth historical time point and a turbidity degree of water storage corresponding to the sixth historical time point. The fifth historical time point may precede the sixth historical time point. The fourth labels may include actual risk assessment data of the sixth historical time point corresponding to the each set of fourth training samples. The fourth training samples may be obtained based on the historical data. The fourth labels may be determined by manual labeling or automatic labeling.

A manner of training the water storage prediction layer and/or the risk prediction layer may be found in the manner of training the anomaly assessment model in FIG. 3 and related descriptions thereof.

The data of the risk prediction layer may be obtained through the above training manner, which is beneficial in some cases to address the difficulty in obtaining labels when the risk prediction layer model is trained alone, and also allows the risk prediction layer model to obtain more accurate environmental water storage data and turbidity degree of water storage.

According to some embodiments of the present disclosure, the risk assessment data may be determined through the risk assessment model, such that the risk assessment data determined through a plurality of the external environmental data can be more accurate.

FIG. 5 is a flowchart illustrating an exemplary process of determining a target scheduling strategy according to some embodiments of the present disclosure. The process of determining the target scheduling strategy based on anomaly assessment data and risk assessment data may also be implemented by a process 500. The process 500 may include the following operations. The process 500 may be implemented by the smart gas pipeline network safety management platform 130 based on the IoT system for monitoring safety of a pipeline network valve well based on smart gas.

In 510, a plurality of candidate scheduling strategies may be generated.

The plurality of candidate scheduling strategies refer to scheduling strategies to be determined as the target scheduling strategy, and may include a scheme for allocating maintenance resources to one or more target maintenance valve wells. In some embodiments, for each of the one or more target maintenance valve wells, the plurality of candidate scheduling strategies may include a count of maintenance personnel and an allocation volume of data bandwidth for the target maintenance valve well.

The count of maintenance personnel refers to a count of maintenance personnel allocated to a certain target valve well for maintenance.

The allocation volume of data bandwidth refers to a volume of channel bandwidth allocated for data upload by the certain target maintenance valve well and associated equipment thereof.

The smart gas pipeline network safety management platform 130 may generate the plurality of candidate scheduling strategies in various ways, e.g., random generation, or the like. In the plurality of candidate scheduling strategies, for the certain target maintenance valve well, the count of maintenance personnel may be negatively correlated with the allocation volume of data bandwidth. For example, the higher the count of maintenance personnel, the smaller the allocation volume of data bandwidth.

In 520, for one of the plurality of candidate scheduling strategies, an assessment value corresponding to the candidate scheduling strategy may be determined.

The assessment value refers to a value obtained by assessing the candidate scheduling strategy.

The smart gas pipeline network safety management platform 130 may determine the assessment value corresponding to one of the plurality of candidate scheduling strategies in various feasible ways, such as evaluation index system, regression analysis, neural network, etc.

In some embodiments, the assessment value may include an anomaly growth rate distribution and/or a failure omission rate.

An anomaly growth rate characterizes an combined accumulation of an anomaly degree of an intrinsic anomaly occurring in the target maintenance valve well and a risk value of an extrinsic risk occurring in the valve well in a time dimension.

The anomaly growth rate distribution characterizes anomaly growth rate distributions of a plurality of target maintenance valve wells.

In some embodiments, for one of the plurality of candidate scheduling strategies, the determining the anomaly growth rate distribution may include: determining an initial anomaly growth rate based on the anomaly assessment data and the risk assessment data; and determining the anomaly growth rate distribution based on the initial anomaly growth rate and the count of maintenance personnel.

The initial anomaly growth rate refers to an anomaly growth rate occurred if no manual intervention (e.g., maintenance) is performed after the intrinsic anomaly and/or the extrinsic risk occurs in the target maintenance valve well.

In some embodiments, the smart gas pipeline network safety management platform 130 may determine the initial anomaly growth rate based on a current anomaly degree, a current risk value, and a risk value at a future time point of the target maintenance valve well.

In some embodiments, the initial anomaly growth rate may be positively correlated with at least one of the current anomaly degree, the current risk value, and the risk value at the future time point of the target maintenance valve well. For example, the initial anomaly growth rate may be calculated by Equation 2:

V₀=k1*V̅_̅{̅a̅b̅}̅+k₂*V̅ᵣ̅+k₃*V_{ab}+k4*Vᵣ (2)

wherein V₀ denotes the initial anomaly growth rate, V̅_̅{̅a̅b̅}̅ denotes an average anomaly degree growth rate, V̅ᵣ̅ denotes an average risk value growth rate, V_{ab} denotes the current anomaly degree, Vᵣ denotes the current risk value, and k1, k2, k3, and k4 denote anomaly growth rate coefficients, respectively. Values of the anomaly growth rate coefficients may be preset based on experience.

The average anomaly degree growth rate V̅_̅{̅a̅b̅}̅ may be determined through the anomaly degrees at a plurality of future time points in the anomaly assessment data corresponding to the target maintenance valve well; and the average risk value growth rate Vᵣ may be determined through the risk values at the plurality of future time points in the risk assessment data corresponding to the target maintenance valve well. The manner of determining the risk values at the plurality of future time points may be found in FIG. 4 and related descriptions thereof.

In some embodiments of the present disclosure, the smart gas pipeline network safety management platform 130 may obtain the anomaly degrees at a plurality of future time points in the anomaly assessment data corresponding to a certain target maintenance valve well, and determine the average anomaly degree growth rate V̅_̅{̅a̅b̅}̅ by calculating the anomaly degree growth rates corresponding to the plurality of future time points. For example, if the anomaly degree at 10:30 is 20, the anomaly degree at 11:00 is 40, and the anomaly degree at 11:30 is 50, the anomaly degree growth rate at 11:00 may be 20 obtained by the anomaly degree at 11:00 minus the anomaly degree at 10:30, the anomaly degree growth rate at 11:30 may be 10 obtained by the anomaly degree at 11:30 minus the anomaly degree at 11:00, and the average anomaly degree growth rate may be 15 obtained by an average of 20 and 10. The manner of determining the average risk value growth rate may be found in the manner of determining the average anomaly degree growth rate.

In some embodiments, the smart gas pipeline network safety management platform 130 may determine a maintenance factor corresponding to each target maintenance valve well s, based on the plurality of candidate scheduling strategies; determine an anomaly growth rate of the target maintenance valve well based on the initial anomaly growth rate of each target maintenance valve well and the maintenance factor corresponding to the target maintenance valve well; and determine the anomaly growth rate distribution based on the anomaly growth rates of the plurality of target maintenance valve wells.

The smart gas pipeline network safety management platform 130 may determine the maintenance factor by querying a preset correspondence table based on the count of maintenance personnel in the plurality of candidate scheduling strategies. The preset correspondence table may include a correspondence between the count of maintenance personnel and the maintenance factor. In the preset correspondence table, the count of maintenance personnel may be positively correlated with the maintenance factor.

In some embodiments, the determining the anomaly growth rate of the target maintenance valve well based on the initial anomaly growth rate and the maintenance factor may include that the anomaly growth rate is equal to the initial anomaly growth rate minus the maintenance factor.

A historical omission probability refers to a probability that an intrinsic anomaly and/or an extrinsic risk occurring in a certain target maintenance valve well at a historical time point is not detected in time. For example, up to a certain historical time point, if a certain valve well has a total of ten intrinsic anomalies and/or extrinsic risks, and one of the ten intrinsic anomalies and/or extrinsic risks is not detected in time, the historical omission probability may be 10%.

An individual omission probability refers to a probability that for one of the plurality of candidate scheduling strategies, an intrinsic anomaly and/or an extrinsic risk occurring in a certain target maintenance valve well is not detected in time.

The failure omission rate refers to a probability of omission rate of the plurality of target maintenance valve wells as a whole for one of the plurality of candidate scheduling strategies.

In some embodiments, for one of the plurality of candidate scheduling strategies, the determining the failure omission rate may include: determining the individual omission probability of the target maintenance valve well based on the count of maintenance personnel, the allocation volume of data bandwidth, and the historical omission probability of the target maintenance valve well; and determine the failure omission rate based on the individual omission probability.

In some embodiments, the smart gas pipeline network safety management platform 130 may determine the individual omission probability of the target maintenance valve well based on the historical omission probability, a historical average count of maintenance personnel, a historical average allocation volume of data bandwidth, and the count of maintenance personnel and the allocation volume of data bandwidth corresponding to the plurality of candidate scheduling strategies.

For one of the target maintenance valve wells, the historical individual omission probability may be equal to a count of omissions divided by a total count of maintenance.

For one of the target maintenance valve wells, the individual omission probability may be positively correlated with at least one of the historical individual omission probability and a difference between the allocation volume of data bandwidth and the historical average allocation volume of data bandwidth, and may be negatively correlated with a difference between the count of maintenance personnel and the historical average count of maintenance personnel. For example, the individual omission probability may be calculated by the following Equation 3:

P=Pₕ−k5*(N−Nₕ)+k6*(B−Bₕ) (3)

where P denotes the individual omission probability, Pₕ denotes the historical individual omission probability, N denotes the count of maintenance personnel, Nₕ denotes the historical average count of maintenance personnel, B denotes the allocation volume of data bandwidth, Bₕ denotes the historical average allocation volume of data bandwidth allocation, k5 denotes a coefficient of the count of maintenance personnel, and k6 denotes a coefficient of the allocation volume of data bandwidth, values of the coefficients may be preset based on experience. The historical average count of maintenance personnel Nₕ may be an average of the count of maintenance personnel allocated to the valve well in the historical data. The historical average allocation volume of data bandwidth Bₕ may be an average of the allocation volume of data bandwidth to the valve well in the historical data.

If the target maintenance valve well is maintained for the first time, the historical individual omission probability of the target maintenance valve well may be set to the average of the historical individual omission probabilities of all the maintained valve wells. Correspondingly, the historical average count of maintenance personnel and the historical average allocation volume of data bandwidth of the target maintenance valve well may be determined with respect to the manner of determining the historical individual omission probability.

The smart gas pipeline network safety management platform 130 may determine the failure omission rate in various ways. For example, the failure omission rate may be determined based on the above individual omission probability. For example, the failure omission rate may be an average of the individual omission probabilities of all the valve wells.

The assessment values of the plurality of candidate scheduling strategies may be determined by obtaining the anomaly growth rate distribution and the failure omission rate, such that the assessment values of the plurality of candidate scheduling strategies can be more accurately and efficiently determined, and thus the most suitable target scheduling strategy can be determined.

In 530, a target scheduling strategy may be determined based on the assessment values corresponding to the plurality of candidate scheduling strategies.

In some embodiments, the smart gas pipeline network safety management platform 130 may determine the target scheduling strategy based on the assessment values corresponding to the plurality of candidate scheduling strategies through a preset algorithm. Merely by way of example, the determining the target scheduling strategy by the preset algorithm may include operations 531-537.

In 531, the target maintenance valve well is numbered, and the plurality of candidate scheduling strategies may be encoded through a preset encoding mode based on a number corresponding to the target maintenance valve well, and the count of maintenance personnel and the allocation volume of data bandwidth for the target maintenance valve well in the plurality of candidate scheduling strategies. The preset encoding mode may include binary encoding, real number encoding, or the like.

For example, if the target maintenance valve well includes a valve well i (numbered i), and the count of maintenance personnel and the allocation volume of data bandwidth for the target maintenance valve well in the plurality of candidate scheduling strategies are denoted as nᵢ and mᵢ, the corresponding candidate scheduling strategies may be encoded as “Ni=(n₁,m₁)”, wherein Ni denotes the valve well i, (n₁,m₁) denotes the count of maintenance personnel n₁ and the allocation volume of data bandwidth m₁ for the valve well i. m₁ may be determined based on n₁.

In 532, an initial population may be set. Codes corresponding to the plurality of candidate scheduling strategies in the operation 521 may be determined as initial individuals; and the plurality of candidate scheduling strategies may correspond to a plurality of initial individuals to form an initial population.

In 533, a fitness corresponding to each of the initial individuals may be determined through a fitness function. The fitness corresponding to each of the initial individuals may be set to the assessment value of the candidate scheduling strategy corresponding to the initial individual. The assessment value of the candidate scheduling strategy may include the anomaly growth rate distribution, the failure omission rate, etc. More descriptions may be found in the related descriptions of the operation 520.

In some embodiments, the fitness may be positively correlated with at least one of the total anomaly growth rate and the failure omission rate. For example, the fitness f may be calculated by the following Equation 4:

f=k7*V+k8*Pₐₗₗ (4)

wherein V denotes the total anomaly growth rate, and Pₐₗₗ denotes the failure omission rate; k7 denotes a coefficient of the total anomaly growth rate V, and k8 denotes a coefficient of the failure omission rate Pₐₗₗ, which may be preset based on experience. The total anomaly growth rate V may be a sum of the anomaly growth rates corresponding to all the target maintenance valve wells in the anomaly growth rate distribution.

In some embodiments, the operation 533 may further include obtaining a sorted list by sorting the initial individuals based on the fitness. In the sorted list, the smaller the fitness of the initial individual, the higher the sorting of the initial individual.

In 534, parent individuals may be determined by performing a selection operation on the plurality of initial individuals based on a selection function. When the selection operation is performed, a probability of being selected of each of the initial individuals may be negatively correlated with the fitness corresponding to the initial individual. The selection function may be determined based on an operator such as roulette.

In some embodiments, the probability of being selected of each of the initial individuals may be calculated by the following Equation 5:

S=1−(f₀÷f) (5)

wherein S denotes the probability of being selected, f₀ the fitness corresponding to each of the initial individuals, and f denotes a total fitness of the plurality of initial individuals.

The selection operation may further include eliminating, based on the fitness in advance, initial individuals of which fitness satisfies a preset elimination condition. The preset elimination condition may include a preset number of initial individuals that belong to the low ranked in the sorted list. For example, if the preset number is three, a certain initial individual belonging to one of the three initial individuals ranked low in terms of fitness in the sorted list may be eliminated. The smart gas pipeline network safety management platform 130 may determine the parent individuals based on new initial individuals and the initial individuals which are not eliminated, and perform subsequent operation.

In 535, child individuals may be generated by crossover operation based on the parent individuals. In the crossover operation, a crossover probability may be any value within a range of 0.4-0.99. The crossover operator may be one of a single-point crossover, a multi-point crossover, or a uniform crossover.

For example, parameters contained in the plurality of candidate scheduling strategies corresponding to the plurality of parent individuals may be crossed with each other to obtain more child individuals, i.e., new candidate scheduling strategies. Merely by way of example, a candidate scheduling scheme A may include five maintenance personnel, and a allocation volume of data bandwidth may be 100 bits. A candidate scheduling scheme B may include three maintenance personnel, and a allocation volume of data bandwidth may be 200 bits. After crossover of the candidate scheduling scheme A and the candidate scheduling scheme B, the candidate scheduling scheme A may include three maintenance personnel, and the allocation volume of data bandwidth may be 100 bits, and the candidate scheduling scheme B may include five maintenance personnel, and the allocation volume of data bandwidth may be 200 bits.

In 536, new initial individuals may be generated by performing a mutation operation on chromosomes of the child individuals, and one current count of evolution may be added. In the mutation operation, a mutation probability may be set to 0.5, and a mutation operator may be one of a basic bit mutation, a uniform mutation, a non-uniform mutation, etc. For example, a parameter of the child individuals may be mutated appropriately to make the parameter more responsive to scheduling needs. Merely by way of example, the count of maintenance personnel in a candidate scheduling strategy corresponding to a certain child individual may be decreased by one person.

In 537, whether a termination condition is satisfied may be determined; in response to determining that the termination condition is satisfied, an initial individual with the smallest fitness of the new initial individuals may be determined, a count of maintenance personnel in a candidate scheduling strategy corresponding to the initial individual may be determined as the count of scheduling personnel, an allocation volume of data bandwidth in the candidate scheduling strategy corresponding to the initial individual may be determined as the volume of scheduling bandwidth, and a target scheduling strategy may be obtained; in response to determining that the termination condition is not satisfied, the operation 523 is continued for continuous evolution until the termination condition is satisfied.

The termination condition may include that a count of evolutions reaches a preset count threshold, etc.

The plurality of candidate scheduling strategies may be determined through the anomaly assessment data and the risk assessment data, and the target scheduling strategy may be obtained from the assessment values of the plurality of candidate scheduling strategies, such that the most effective candidate scheduling strategy can be accurately obtained as the target scheduling strategy, and the available resources and the maintenance needs can be better balanced.

The smart gas pipeline network maintenance engineering object sub-platform may implement the determined target scheduling strategy for the target maintenance valve well. The target maintenance valve well may be determined in other ways.

In some embodiments, the smart gas pipeline network maintenance engineering object sub-platform may also determine the target maintenance valve well based on the anomaly type and/or the anomaly degree at the future time point in the anomaly assessment data and the risk value at the future time point in the risk assessment data.

In some embodiments, the smart gas pipeline network safety management platform 130 may determine, based on the anomaly type and/or the anomaly degree at the future time point in the anomaly assessment data and the risk value at the future time point in the risk assessment data, a second emergency degree of the valve well, based on an emergency condition; and determine, based on the second emergency degree of each valve well, a valve well of which the second emergency degree satisfies a second emergency condition as the target maintenance valve well.

Merely by way of example, the second emergency degree of the valve well may be determined by performing weighted summation on an average of the anomaly degrees, an average of the risk values, and an importance degree of the valve well. A fourth weighting coefficient of the weighted summation may be preset based on experience. The average of the anomaly degrees may be an average of anomaly degrees corresponding to a plurality of future time points. The average of the risk values may be an average of the risk values corresponding to the plurality of future time points.

If the valve well has a plurality of anomalies, and each of the plurality of anomalies corresponds to a different anomaly degree, the average of the anomaly degrees corresponding to each anomaly may be determined separately, and a maximum value of the average may be selected.

The second emergency condition may include that the second emergency degree is greater than a second emergency threshold. The second emergency threshold may be preset based on experience.

According to some embodiments of the present disclosure, the valve well of which the emergency degree is higher may be selected and determined as the target maintenance valve well based on the anomaly type and/or the anomaly degree at the future time point in the anomaly assessment data and the risk value at the future time point in the risk assessment data, such that the target valve well with the more emergency condition can be handled in a targeted manner using the limited maintenance resources.

In some embodiments, the target maintenance valve well may be determined based on the anomaly type and/or the anomaly degree at the future time point in the anomaly assessment data and the risk value at the future time point in the risk assessment data. The valve well with a high anomaly degree may be located by priority according to the emergency degree of the anomaly, helping the relevant staff to deal with the anomaly as soon as possible, reducing the risk and loss brought about by the anomaly, thereby better ensuring the safety of gas usage for the user.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A method for monitoring safety of a pipeline network valve well based on smart gas, implemented by a smart gas pipeline network safety management platform of an Internet of Things (IoT) system for monitoring safety of a pipeline network valve well based on smart gas, comprising:
obtaining gas monitoring data of a valve well, the gas monitoring data including at least one of gas pressure data, gas flow data, gas temperature data, and gas humidity data;
obtaining external environmental data of the valve well, the external environmental data including environmental water storage data;
determining anomaly assessment data of the valve well based on the gas monitoring data;
determining risk assessment data of the valve well based on the external environmental data;
determining a target maintenance valve well and a target scheduling strategy based on the anomaly assessment data and the risk assessment data, the target scheduling strategy including a count of scheduling personnel and a volume of scheduling bandwidth; and
sending the target scheduling strategy to a smart gas pipeline network maintenance engineering object sub-platform.

2. The method of claim 1, wherein the gas monitoring data further includes valve well monitoring data and pipeline monitoring data, an acquisition frequency of the valve well monitoring data is a first acquisition frequency, an acquisition frequency of the pipeline monitoring data is a second acquisition frequency,
the first acquisition frequency is greater than the second acquisition frequency;
the second acquisition frequency is negatively correlated with a distance between a gas pipeline and a valve well closest to the gas pipeline.

3. The method of claim 1, wherein the determining anomaly assessment data of the valve well based on the gas monitoring data includes:
constructing a valve well pipeline network diagram based on the gas monitoring data and valve well parameters;
determining the anomaly assessment data through an anomaly assessment model based on the valve well pipeline network diagram, wherein the anomaly assessment data includes an anomaly type and/or an anomaly degree of an intrinsic anomaly occurring in the valve well at a current time point and/or a future time point.

4. The method of claim 3, wherein nodes in the valve well pipeline network diagram include pipeline nodes and valve well nodes, wherein valve well node features of the valve well nodes include the environmental water storage data; edges in the valve well pipeline network diagram include a connection relation between the valve well and the pipeline, and a connection relation between the pipelines.

5. The method of claim 1, wherein the determining risk assessment data of the valve well based on the external environmental data includes:
determining the risk assessment data through a risk assessment model based on at least one of the environmental storage data, soil quality data, and valve well structure data, wherein the environmental storage data includes a turbidity degree of water storage and/or a water level of water storage, and the risk assessment data includes a risk value of an extrinsic risk occurring in the valve well.

6. The method of claim 5, wherein an input of the risk assessment model further includes environmental vibration data and/or the anomaly assessment data of the valve well.

7. The method of claim 5, wherein the risk assessment model includes a water storage prediction layer and a risk prediction layer,
the water storage prediction layer is configured to determine predicted environmental water storage data based on at least one of the environmental water storage data, predicted precipitation, and the soil quality data;
the risk prediction layer is configured to determine the risk assessment data based on at least one of the environmental storage data, the predicted environmental storage data, the valve well structure data, and the soil quality data, the risk assessment data including the risk value of the extrinsic risk occurring in the valve well at a future time point.

8. The method of claim 1, wherein the determining a target maintenance valve well and a target scheduling strategy based on the anomaly assessment data and the risk assessment data includes:
generating a plurality of candidate scheduling strategies, the plurality of candidate scheduling strategies including a count of maintenance personnel and an allocation volume of data bandwidth for the target maintenance valve well;
for one of the plurality of candidate scheduling strategies, determining an assessment result corresponding to the candidate scheduling strategy; and
determining the target scheduling strategy based on the assessment results corresponding to the plurality of candidate scheduling strategies.

9. The method of claim 8, wherein the determining the target maintenance valve well includes:
determining the target maintenance valve well based on an anomaly type and/or an anomaly degree of the anomaly assessment data at a future time point, and a risk value of the risk assessment data at the future time point.

10. The method of claim 9, wherein the assessment result includes an anomaly growth rate distribution and/or a failure omission rate; for one of the plurality of candidate scheduling strategies:
determining the anomaly growth rate distribution includes:
determining an initial anomaly growth rate based on the anomaly assessment data and the risk assessment data; and
determining the anomaly growth rate distribution based on the initial anomaly growth rate and the count of maintenance personnel;
determining the failure omission rate includes:
determining an individual omission probability of the target maintenance valve well based on the count of maintenance personnel, the allocation volume of data bandwidth, and historical omission probabilities of the target maintenance valve well; and
determining the failure omission rate based on the individual omission probability.

11. An Internet of Things (IoT) system for monitoring safety of a pipeline network valve well based on smart gas, comprising a smart gas user platform, a smart gas service platform, a smart gas pipeline network safety management platform, a smart gas pipeline network sensor network platform, and a smart gas pipeline network object platform, wherein
the smart gas user platform includes a gas user sub-platform and a supervision user sub-platform;
the smart gas service platform includes a smart gas usage service sub-platform and a smart supervision service sub-platform;
the smart gas pipeline network safety management platform includes a smart gas pipeline network risk assessment management sub-platform and a smart gas data center;
the smart gas sensor network platform is configured to interact with the smart gas data center and the smart gas pipeline network object platform;
the smart gas pipeline network object platform includes a smart gas pipeline network equipment object sub-platform and a smart gas pipeline network maintenance engineering object sub-platform; the smart gas pipeline network equipment object sub-platform is configured to collect gas monitoring data of a valve well and external environmental data of the valve well; the smart gas pipeline network maintenance engineering object sub-platform is configured to implement a target scheduling strategy for a target maintenance valve well;
the smart gas pipeline network safety management platform is configured to obtain the gas monitoring data of the valve well, the gas monitoring data including at least one of gas pressure data, gas flow data, gas temperature data, and gas humidity data; obtain the external environmental data of the valve well, the external environmental data including environmental water storage data; determine anomaly assessment data of the valve well based on the gas monitoring data; determine risk assessment data of the valve well based on the external environmental data; determine the target maintenance valve well and the target scheduling strategy based on the anomaly assessment data and the risk assessment data, the target scheduling strategy including a count of scheduling personnel and a volume of scheduling bandwidth; and send the target scheduling strategy to the smart gas pipeline network maintenance engineering object sub-platform.

12. The IoT system of claim 11, wherein the gas monitoring data further includes valve well monitoring data and pipeline monitoring data, an acquisition frequency of the valve well monitoring data is a first acquisition frequency, and an acquisition frequency of the pipeline monitoring data is a second acquisition frequency,
the first acquisition frequency is greater than the second acquisition frequency;
the second acquisition frequency is negatively correlated with a distance between a gas pipeline and a valve well closest to the gas pipeline.

13. The IoT system of claim 11, wherein the smart gas pipeline network safety management platform is further configured to:
construct a valve well pipeline network diagram based on the gas monitoring data and valve well parameters; and
determine the anomaly assessment data through an anomaly assessment model based on the valve well network diagram, wherein the anomaly assessment data includes an anomaly type and/or an anomaly degree of an intrinsic anomaly occurring in the valve well at a current time point and/or a future time point.

14. The IoT system of claim 13, wherein nodes in the valve well pipeline network diagram include pipeline nodes and valve well nodes, valve well node features of the valve well nodes include the environmental water storage data; edges in the valve well pipeline network diagram include a connection relation between the valve well and the pipeline, and a connection relation between the pipelines.

15. The IoT system of claim 11, wherein the smart gas pipeline network safety management platform is further configured to:
determine the risk assessment data through a risk assessment model based on at least one of the environmental storage data, soil quality data, and valve well structure data, wherein the environmental storage data includes a turbidity degree of water storage and/or a water level of water storage, and the risk assessment data includes a risk value of an extrinsic risk occurring in the valve well.

16. The IoT system of claim 15, wherein an input of the risk assessment model further includes environmental vibration data and/or the anomaly assessment data of the valve well.

17. The IoT system of claim 15, wherein the risk assessment model includes a water storage prediction layer and a risk prediction layer,
the water storage prediction layer is configured to determine predicted environmental water storage data based on at least one of the environmental water storage data, predicted precipitation, and the soil quality data;
the risk prediction layer is configured to determine the risk assessment data based on at least one of the environmental storage data, the predicted environmental storage data, the valve well structure data, and the soil quality data, the risk assessment data including the risk value of the extrinsic risk occurring in the valve well at a future time point.

18. The IoT system of claim 11, wherein the smart gas pipeline network safety management platform is further configured to:
generate a plurality of candidate scheduling strategies, the plurality of candidate scheduling strategies including a count of maintenance personnel and an allocation volume of data bandwidth for the target maintenance valve well;
for one of the plurality of candidate scheduling strategies, determine an assessment result corresponding to the candidate scheduling strategy; and
determine the target scheduling strategy based on the assessment results corresponding to the plurality of candidate scheduling strategies.

19. The IoT system of claim 18, wherein the smart gas pipeline network safety management platform is further configured to:
determine the target maintenance valve well based on an anomaly type and/or an anomaly degree of the anomaly assessment data at a future time point, and a risk value of the risk assessment data at the future time point.

20. The IoT system of claim 19, wherein the assessment result includes an anomaly growth rate distribution and/or a failure omission rate, and the smart gas pipeline network safety management platform is further configured to:
determine the anomaly growth rate distribution, including:
determining an initial anomaly growth rate based on the anomaly assessment data and the risk assessment data; and
determining the anomaly growth rate distribution based on the initial anomaly growth rate and the count of maintenance personnel;
determine the failure omission rate, including:
determining an individual omission probability of the target maintenance valve well based on the count of maintenance personnel, the allocation volume of data bandwidth, and historical omission probabilities of the target maintenance valve well; and
determining the failure omission rate based on the individual omission probability.
